(19) United States
(12) Patent Application Publication
(10) Pub. No.: US 2007/0106476 A1
(43) Pub. Date: May 10, 2007

(54) Method and system for forming decoding device

(76) Inventors: Robin Bratchley, Reading (GB); John Philip Winchcombe, Hampshire (GB)

Correspondence Address: OLIFF & BERRIDGE, PLC, P.O. BOX 19928, ALEXANDRIA, VA, 22320, US

(21) Appl. No.: 10/587,043

(22) PCT Filed: Apr. 29, 2005
(86) PCT No.: PCT/GB05/01640

§ 371 Date: Aug. 22, 2006

(30) Foreign Application Priority Data
May 4, 2004 (GB) 0409923.0

(51) Int. Cl. G06F 19/00

(52) U.S. Cl. 702/1

(57) ABSTRACT

A method of forming a decoding device to enable hidden information or indicia on an article to be revealed is described. The method comprises electronically transferring data defining the decoding device from a central source (3) to a remote site (6). The decoding device is created at the remote site (6) using the transmitted data.

The invention relates to methods and systems for forming a decoding device to enable hidden information or indicia on an article to be revealed.

It is well known in the security printing business that hand held viewers or revealers can be used to reveal a hidden image in a security printed document. Typically a print element contains a camouflaged code or image that is revealed when the viewer is placed between the eye and the encoded document.

The hidden images and the type of revealer can take several forms. The following approaches are described in the prior art.

WO 01/87632 discloses a print feature consisting of an array of dots in which a security pattern or code is produced by displacing some of the dots with respect to the rest. This cannot be seen with the naked eye. The pattern can be made visible by viewing through a planar device carrying transparent and opaque areas of the same periodicity as the printed dots.

WO 97/20298 discloses a method and apparatus for producing Scrambled Indicia®. This process encodes a message or image into an area of print using digital techniques. The message cannot be seen by unaided eye. When the print is viewed using a lenticular screen of the correct characteristics the hidden image/message is revealed. In some cases different images can be seen at different angles of view. Such scrambled indicia can be incorporated into print or into holographic originations.

Enschede's microSAM™ feature uses screen angle modulation to encode a message or image by modifying the print structure in a manner undetectable by the unaided eye. When the feature is viewed through the correct revealer the hidden message or pattern is seen. The revealer in this case is a piece of plastic film ruled with parallel black lines of the correct pitch and thickness.

WO 01/39138 discloses methods and apparatus for authenticating security documents such as banknotes, passports etc. According to this method, a screen pattern is printed onto a surface. A revealing device is designed so that when it is placed over the printing, it produces a clearly visible message or image caused by the moire effect. The revealing screen may be a line structure or a microlens array.

GB 1407065 describes a security document carrying a pair of metameric inks which match under one illuminant, say North Sky light, but mismatch under another type of illuminant, such as tungsten. For such a set of inks it is also possible to see a difference in the appearance of the two pairs of such inks by viewing under coloured filters. Commonly, a red filter is used for viewing features. Any mismatch in the absence of a viewer is hidden by overprinting the ink pair by a discontinuous red print design which drops out under the filter.

EP 930979 discloses a self-verifying document and describes a number of methods by which a transparent region on the document can be used to authenticate a document. Microlenses, diffraction gratings, colour filters and moire effects are all referred to.

In all the above effects the security benefits rely on the fact that when the document is copied the structure of the hidden images are not precisely replicated by the copying process. For example this will occur if the resolution of the original image is significantly greater than the resolution of the device used to replicate the image.

Although the technology described in the above prior art provides an effective way of authenticating documents by making use of hidden features in printed security documents it is necessary to have a revealing device appropriate to the feature readily available. Each of the devices described in the prior art will require a viewer specifically designed for that device. Interested users could be issuing authorities, national banks, commercial banks, forensic laboratories, retailers (both point of sale and back office applications) or the general public. Each level of user could have different security requirements.

Revealing devices can be manufactured and be made available for issue at points of sale, commercial banks etc. However considerable infrastructure is required to manufacture and distribute such items nationwide and possibly farther afield. There is also the concern that the particular revealer is not matched to the feature in question as a variety of structures are possible which could vary from document to document. A reliable means of delivery is required to ensure a cost effective, technically effective and speedy supply of revealers to users.

One approach (EP-A-0930979) currently used on plastic banknotes is to provide a viewer on the same document as the printed feature to be decoded i.e. a self-authenticating document. This has the drawback that, for security documents produced on non-transparent substrates, the method cannot be used. In addition there is no control over the level of security control in the issue of viewers. All such revealers are in the public domain. Also the revealer on self authenticating documents can deteriorate by repeated handling as would be the case in circulated documents such as the banknote. The effectiveness of such self-authenticating documents will therefore reduce steadily as they are repeatedly handled.

In accordance with a first aspect of the present invention, a method of forming a decoding device to enable hidden information or indicia on an article to be revealed comprises electronically transferring data defining the decoding device from a central source to a remote site, and creating the decoding device at the remote site using the transmitted data.

In accordance with a second aspect of the present invention, a method of checking the validity of a security device on an article comprises forming a decoding device at a remote site using data transferred electronically from a central source; and viewing the decoding device in association with the security device to validate the security device.

In accordance with a third aspect of the present invention, a decoding device forming system comprises a central source for providing data defining a decoding device to enable hidden information or indicia on an article to be revealed; a transmission system for transmitting data from the central source to a remote site; and a creation system at the remote site for creating the decoding device using the transmitted data.

In this invention, the decoding device or revealer is created on demand at the remote site using data transferred electronically from the central source. This has a number of advantages. It is convenient for users since they do not need to obtain decoding devices in advance and in addition do not need to store them but can simply download them as required. When there are changes in security features which require different decoding devices, these changes can be implemented at the central source and, in some cases, the user does not even need to know that there has been a change. The problems of degradation in revealing or decoding devices are avoided. Furthermore, of course, the complex infrastructure needed to manufacture and distribute decoding devices is completely avoided.

Typically, the article on or in which the hidden information or indicia is provided comprises a document of value. Such documents include banknotes, fiscal stamps, certificates of authenticity, cheques, bonds, retail vouchers, postage stamps, passports, identity documents, and travellers cheques. However, the information or indicia could be provided on a variety of articles such as banknote cassettes and other secure containers.

Typically, the central source comprises a database which is loaded with data defining the decoding device, for example defining the colour or black and white content of a decoding image. That colour or black and white content may be defined in the form of pixel data or vector data. Alternatively, or in addition, it will supply data which defines line structures, dot structures or 3D characteristics that are required for the viewer.

In other cases, however, the central source may include a processor which generates the data in accordance with a predetermined algorithm, on demand.

Examples of decoding devices include an optical filter, a line, or dot pattern, coloured filter, curved line structure, concentric circles, geometric figures, microlens arrays, lenticular screens, lenses and Fresnel lenses or any combination thereof. Such devices could be downloaded and created using systems of the type offered by Z Corporation (http://www.zcorp.com/), Dimension (http://www.dimensionprinting.com/news_pr_sst. html) and Versa Laser (http://www.versalaser.com/english/index.html), and www.pattech.com.

In some examples, the step of creating the decoding device comprises outputting the decoding device on a record medium such as paper, plastic, glass or other suitable material. Other methods include engraving, ablating and moulding. In some cases, the record medium is transparent which enables the security device including the hidden information or indicia to be viewed through the decoding device when the record medium is laid over the security device.

In other examples, the step of creating the decoding device comprises displaying the decoding device on a display screen, such as a high resolution display screen, monitor or high intensity display. In this case, an image is displayed on the screen and the test article or document is placed over the displayed image. The observer will see an effect, image or message appear when the document and screen images are viewed together. The displayed image may be stationary and may take a variety of forms including line structures, dot structures, coloured area, coloured areas, curved line structure, concentric circles or geometric figures.

In some cases, the display screen will be provided on a relatively fixed device such as a desktop monitor. However, in a particularly preferred aspect of the invention, the display screen is provided in a portable device such as a mobile telephone or PDA. This has a number of significant advantages. Thus, for example, prior to travelling on holiday to a foreign country, one can download the relevant decoding device onto a mobile phone or PDA for the local currency in the country. Once abroad, the mobile device can be used to authenticate the local currency. This is particularly advantageous as it is when in a foreign country handling unfamiliar cash that one is most likely to accept a fake. It also has the additional benefit that it could provide information such as the denomination, which is very useful in countries that use different alphanumeric characters. Similarly, a phone or PDA could be used by officials to test the validity of other security documents such as fiscal stamps when out in the field.

Alternatively, the displayed image or a component of the displayed image can vary with time. For example, colour, the pitch and/or widths of lines, the pitch or diameter of dots or the geometry of the image may change. When a security device on an article is held over the variable screen image, this can produce different composite images at different times—these images not being apparent by observing the screen or the device alone. By the use of appropriate algorithms (down-loadable from a central website), it is also possible to provide interactive procedures for authentication of an article or document. For example, a key on a computer keyboard can be pressed when a particular image is produced and the status of the system at that time will give an added factor in authenticating the document. This can be used to output an appropriate signal such as a display or audible signal.

The data can be electronically transferred using any conventional transfer medium including the Internet, satellite, cable, PSTN and mobile telephone networks. Thus, the data can be transmitted by email, radio, for example being broadcast by FM, terrestrial TV or satellite sideband. Alternatively, the data could be downloaded direct from a central hub in a point to point manner.

The step of creating the decoding device could typically be carried out by one of an ink jet printer, laser printer, 3D ink jet printing device, laser engraver, laser marker, laser ablating device, laser cutter, fax machine, commercial ink jet, digital press, conventional press or computer operated machine. The printer could be colour or black and white. The data could be received by any of a personal computer (PC), PDA, mobile phone and the like.

In some cases, the data will be transferred to any remote site which requests it. However, it may be desirable in some cases only to release the data to authorised users. To that end, the method may further comprise supplying access control data to the central source to enable the data to be accessed. The accessed control data could comprise a PIN, password, biometric data or digital certificate.

In some cases, an image of or on the article or a serial number of the article to be authenticated could be supplied to the central source to enable the correct decoding device to be accessed.

It is highly preferred that the data file carrying the information for production of the viewer should be resistant to tampering and unauthorised access. Various security levels of access could be introduced.

The man in the street could have access to a low security level colour filter viewer.

A commercial bank could have access in addition to a higher security level line structure viewer.

A central bank could in addition have access to a microlens array viewer having the highest security level.

Alternatively, viewers with line structures of different dimensions or pitches can be made available at the different access levels either to work with the same area of the document or to work with different areas on the document. Each viewer would then produce its own distinctive image.

Some examples of methods and systems according to the invention will now be described with reference to the accompanying drawing, in which:

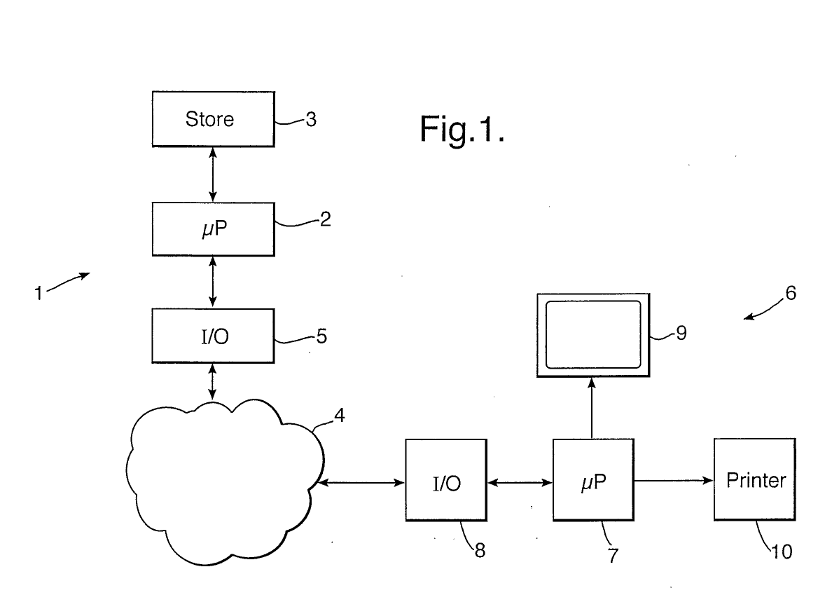

FIG. 1 is a schematic block diagram of an example of the system.

The system shown in FIG. 1 comprises a central site 1 having a microprocessor 2 coupled with a store 3 which stores pixel data for a variety of different decoding devices. The microprocessor 2 is selectively connectable to a communication network 4 such as the Internet or PSTN by an interface 5 such as a modem.

The network 4 enables data from the store 3 to be transferred to any remote user who connects to the central location. The primary components at a typical remote user site 6 are shown in FIG. 1. These comprise a microprocessor 7 coupled via an interface 8 with the network 4. The microprocessor 7 controls selectively one or both of a monitor 9 and printer 10.

When a user at a remote site wishes to obtain a decoding device, he makes contact using his microprocessor 7 and the network 4 with the central site 1 and supplies a user ID and an access code such as a PIN together with details of the decoding device which he requires. Once the PIN has been authenticated by the microprocessor 2, the microprocessor obtains the appropriate data from the store 3 and supplies this either encrypted or in clear, via the network 4, to the microprocessor 7. The microprocessor 7 then prints the decoding device by suitably controlling the printer 10 and/or displays the decoding device on the monitor 9. If the decoding device has been printed, the user then takes the printed decoding device and associates it with the security device on the article whose authenticity is to be determined to see whether any hidden information or indicia are revealed. Alternatively, if the decoding device has been displayed on the monitor 9, the user places the security device over or beside the displayed decoding device.

Some examples of particular security devices and corresponding decoding devices will now be described.

Metameric Hidden Feature

A user has a banknote on which is provided a metameric feature that requires a decoding device or viewer in order to be validated. In order to obtain the decoding device the user accesses the secure website 1 using his PC 7 with a suitable network or Internet connection 4. The web site may require the user to provide some form of identifier before providing the decoding device; such an identifier could be the serial number on the banknote. Alternatively the user may be required to identify the issuing authority and denomination of the banknote.

Once the user has provided the required information a data file is made available. The data file in this instance could have been generated using graphic arts program such as Corel Draw™. In this first example, the decoding device is a coloured filter for viewing printed metameric inks. A decoding device is produced by creating a filled shape, i.e. a red rectangle, which can be saved in any suitable file format, e.g. gif, jpeg, doc etc. This is then printed locally onto a transparent medium such as overhead projector film via an inkjet or colour laser printer 10. The size of the rectangle should be large enough to cover the metameric printed area to be verified. The user then places the printed red filter over the region containing the metameric feature to reveal the hidden image, thus authenticating the security feature. If no hidden image is revealed it indicates the security device may be suspect. Instructions on how to use the decoding device to authenticate the security feature may be provided on screen or printed onto the substrate alongside the decoding device.

Line Structure

As with the above example, a user has a banknote they wish to validate. In this instance the banknote has a concealed feature in a printed image that requires a line grating of a specific frequency in order to be visualised. In order to access the data defining the viewer the user is required to provide an image of the document to be validated. To this end the user must capture the image using a suitable imaging device such as a web cam, digital camera, mobile phone camera or scanner. The image is then forwarded to the central source 1 where it is used to determine which decoding device to make available to the user. Once the banknote image has been identified the data defining the decoding device is made available to the user. In this instance the data defines an area of repeated black lines again created in a suitable graphics program. This can then be printed onto a transparent medium such as OHP film via an inkjet or laser printer 10. The area of lines should be large enough to cover the printed area bearing the concealed image. The decoding device can then be used to reveal the concealed printed image.

Metameric Feature 2

In this example, a banknote is provided with a transparent region over which has been printed a specific shade of red to produce a red filter. In order to validate the banknote the user must access a specified website 1 and to achieve this, the user may be required to provide some additional information. The additional information may be details about themselves or the note they wish to validate. Once allowed access to the specified website an image to be viewed through the filter on the banknote is provided as an image on the monitor 9 displaying the web page. The user then holds the banknote to be validated up to the screen and then looks at the image on the screen through the red filter. If the banknote has the correct type of filter a message or symbol will be revealed.

The image on the monitor 9 could be, for example, a region of green comprising two areas. The first area could be a background and coloured green, the colour being 85, 255, 128 for the hue, saturation and luminance respectively (or R 0, G 255, B 0). The second area could be indicia or a graphical image superimposed on the background and coloured a slightly different green with hue, saturation and luminance values of 64, 255 and 128 respectively (or R 127, G 255, B 0). To the unaided eye, it is not possible to distinguish easily the two areas. However, when the user holds the banknote to be validated up to the screen and looks at the green region on the screen through the red filter, the hidden message or graphical image is displayed. This is due to the absorption of the RGB green emission by the red filter producing a black background while the indicia with 50% RGB red and 100% RGB green appears lighter as the red component is not absorbed by the red filter.

Combined Metameric and Line Grating Security Device

On the banknote or document to be validated, there is printed a line pattern in a pair of metameric inks. There are two levels of security within the feature, the first level being provided by the line grating whereby a hidden image on the document is revealed only when it is viewed in combination with a decoding device comprising a corresponding line grating. The second level of security is provided by a secondary pattern consisting of the pair of metameric inks. This secondary pattern is only revealed when viewed in combination with a decoding device comprising a coloured filter.

The different decoding devices may be made available to different users depending on their level of security access or alternatively, the decoding device may comprise areas of the coloured filter and areas of the particular line grating which perfectly align with areas within the security device thereby revealing both patterns simultaneously. In another embodiment of the invention, the decoding device may be a particular line grating printed in a coloured ink such that it acts as a line grating decoding device and a coloured filter decoding device simultaneously.

This invention has the added benefit of providing different levels of security which will work against different types of counterfeit attempt. A high-resolution scan and inkjet print of a security document may succeed in reproducing with sufficient quality a particular line pattern. However, the metameric feature will not be reproduced.

A standard metameric feature could be reproduced by lithographic or other means, however, the added complexity of including a fine line structure would make it more difficult to achieve both the metameric and the line structure hidden images simultaneously.

Decoding Devices

The decoding device can be a straightforward line grating comprising for example an array of parallel lines. The security device comprises a corresponding array of lines which are modified in some way to hide an image which is only visible when viewed in combination with the decoding device.

An alternative decoding device would comprise a line grating which is modified to contain hidden images. These are only revealed when viewed in combination with the security device, the security device itself comprising an array of parallel lines.

In this way, there is no secure information on the original document so a would-be counterfeiter would not know that any hidden image exists or what it should be. However, when a user wishes to verify the note, instructions accompanying the decoding device would tell the viewer what he should see.

The line structure on the original document is such that copying it via scanner/printer/colour copier, would not reproduce it accurately enough so that when viewed in combination with the decoding device no hidden images are revealed.

Alternatively, hidden images can be provided on both the security device and the decoding device such that when viewed in combination, a double image is revealed. The images may be the same or different. If different, each image could be part of an overall image which is only completed when the correct decoding device and security device are viewed together.

In addition to downloading decoding devices, it would also be possible to use the same technology to download templates.

The template can be used by the visually impaired to check the size of their banknote in order to sort denominations. In many countries each denomination is a different size to prevent upgrading of values and assist in denominating. The template could also be used to locate other features such as thread location, foil location, etc.

1. A method of forming an optical decoding device to enable hidden information or indicia on an article to be revealed, the method comprising electronically transferring data defining the decoding device from a central source to a remote site, and creating the optical decoding device at the remote site using the transmitted data.

2. A method according to claim 1, wherein the article comprises an article of value such as a document, for example selected from the group of banknotes, fiscal stamps, certificates of authenticity, cheques, bonds, retail vouchers, postage stamps, passports, identity documents, and travellers cheques.

3. A method according to claim 1, wherein the central source comprises a database.

4. A method according to claim 1, wherein the data defines one or more of the colour or black and white content of a decoding image, a line structure, or a 3-D structure.

5. A method according to claim 4, wherein the data defines the colour or black and white content of the decoding device in the form of pixel data or vector data.

6. A method according to claim 1, wherein the decoding device comprises one or more of an optical filter, a line or dot pattern, coloured filter, curved line structure, concentric circles, geometric figures, microlens arrays, lenticular screens, lenses and Fresnel lenses.

7. A method according to claim 1, wherein the step of creating the decoding device comprises printing, engraving or ablating the decoding device on a record medium.

8. A method according to claim 7, wherein the record medium comprises paper or plastic.

9. A method according to claim 7, wherein the record medium is transparent.

10. A method according to claim 1, wherein the creating step is carried out by one of an ink jet printer, laser printer, 3D ink jet printing device, laser engraver, laser marker, laser ablating device, laser cutter, fax machine, commercial ink jet, digital press, conventional press or computer operated machine.

11. A method according to claim 1, wherein the step of creating the decoding device comprises displaying the decoding device on a display screen, such as a high resolution display screen, monitor or high intensity display.

12. A method according to claim 11, wherein the transferred data defines a decoding device whose appearance varies with time.

13. A method according to claim 12, wherein the variation is one or more of colour, the pitch and/or widths of lines, the pitch or diameter of dots, or the geometry of the image.

14. A method according to claim 11, wherein the display screen is provided in a portable device such as a mobile telephone or PDA.

15. A method according to claim 1, wherein the data is transmitted by one or more of the Internet, satellite, cable, PSTN and mobile telephone networks.

16. A method according to claim 1, further comprising supplying access control data to the central source to enable the data to be accessed.

17. A method according to claim 16, wherein the access control data comprises a PIN, password, digital certificate, biometric data, or a serial number of the article.

18. A method according to claim 16, wherein the access control data comprises an image of or on the article.

19. A method according to claim 1, wherein the central source is adapted to transfer data defining decoding devices corresponding to different levels of security.

20. A method according to claim 19, wherein the level of security of the transferred decoding device is determined in accordance with the identity of the remote site.

21. A method according to claim 1, further comprising recording details of the identity of a user at a remote site requesting data from the central source.

22. An optical decoding device which has been formed by a method according to claim 1.

23. A method of checking the validity of a security device on an article, the method comprising forming an optical decoding device at a remote site using data transferred electronically from a central source; and viewing the optical decoding device in association with the security device to validate the security device.

24. A method according to claim 23, wherein the article comprises an article of value such as a document, for example selected from the group of banknotes, fiscal stamps, certificates of authenticity, cheques, bonds, retail vouchers, postage stamps, passports, identity documents, and travellers cheques.

25. A method according to claim 23, wherein the security device comprises a hidden code not readily visible to the naked eye.

26. A method according to claim 23, wherein the security device comprises one or more of an array of dots, scrambled indicia, line pattern and metameric feature.

27. A method according to claim 23, wherein the decoding device is formed on a transparent substrate and is placed over the security device to validate it.

28. A method according to claim 23, wherein the forming step is carried out by electronically transferring data defining the decoding device from the central source to the remote site, and creating the optical decoding device at the remote site using the transmitted data.

29. An optical decoding device forming system comprising a central source for providing data defining an optical decoding device to enable hidden information or indicia on an article to be revealed; a transmission system for transmitting data from the central source to a remote site; and a creation system at the remote site for creating the optical decoding device using the transmitted data.

30. A system according to claim 29, wherein the creation system comprises one of an ink jet printer, laser printer, 3D ink jet printing device, laser engraver, laser marker, laser ablating device, laser cutter, fax machine, commercial ink jet, digital press, conventional press or computer operated machine or a display screen, such as a high resolution display screen, monitor or high intensity display.

31. A system according to claim 29, wherein the central source comprises a database.

32. A system according to claim 29, further comprising a processor located at the central source for controlling access to data in the central source.

33. A system according to claim 29, wherein the decoding device comprises an image or indicia which, when viewed in association with a security device, reveals hidden information or indicia within the security device.

34. A system according to claim 29, adapted to electronically transfer the data defining the optical decoding device from the central source to the remote site, and create the optical decoding device at the remote site using the transmitted data.

35. A decoding device supply system comprising a central source for supplying data defining a decoding device to enable hidden information or indicia on an article to be revealed, to one or more remote sites.

36. A system according to claim 35, wherein the central source comprises a database.
